(19) United States
(12) Patent Application Publication
(10) Pub. No.: US 2009/0110599 A1
(43) Pub. Date: Apr. 30, 2009

(54) METHODS OF OPERATING FILM SURFACE REACTORS AND REACTORS EMPLOYING SUCH METHODS

(76) Inventor: Richard A. HOLL, Camarillo, CA (US)

Correspondence Address: Richard A. Holl, 7096 Quito Court, Camarillo, CA, 93012, US

(21) Appl. No.: 11/929,862

(22) Filed: Oct. 30, 2007

(51) Int. Cl. B01J 19/00

(52) U.S. Cl. 422/68.1; 422/187

(57) ABSTRACT

In new methods of operating surface reactors, and new reactors employing such methods, the reactor comprises a cylindrical rotor and a cylindrical stator coaxial with one another with respective cylindrical faces forming an annular reaction chamber between them, the chamber being filled with air or inert gas constituting a shear transmitting fluid. The volume of the reactants, one of which at least must be in liquid state, fed into the chamber is only such that they will immediately be spread out under centrifugal force on the stator surface by the shear transmitting fluid in the form of a film of thickness not more than 150 micrometers, preferably not more than 120 micrometers, and more preferably less than 100 micrometers. The rotor is rotated at high speed, usually about 30,00 to 80,000 rpm, and at these speeds molecular clusters which normally slow down one on one molecular encounters between the reactant molecules, are disrupted by the high shear to facilitate forced, uniform molecular interdiffusion, so that the molecules more aggressively and quickly interact with one another with considerably increased rates of reaction, e.g 100 to 1,000 times increase. This use of an intermediate shear transmitting gaseous fluid gives flexibility in the radial dimension of the reaction chamber, which can be 1 mm or larger, avoiding the need for a reaction chamber of radial dimension corresponding to the desired film thickness and its attendant difficulties, due for example to differential expansion of the rotor and stator with rotation and temperature changes.

### FIELD OF THE INVENTION

The invention is concerned with new methods of operating surface reactors, and with new reactors employing such methods, and especially to methods and reactors employing gas-shearing of reactant films to facilitate reaction between the reactants.

### BACKGROUND OF THE INVENTION

Frequently it is necessary to change the chemical or bio-chemical reactants employed in the synthesis of active pharmaceutical ingredients (APIs) or intermediates. These usually comprise small molecules or molecular building blocks which subsequently are used in the production of the required pharmaceutical compound. Such reactions usually involve the use of very expensive reagents, solvents and catalysts, which are reacted in batch reactors of minimal volume to keep the production costs at a minimum. Typically, one or even less than one milliliter of each reagent is employed, the reagents being simply added together in a small enough single vessel or a plurality of vessels, the contents of which are then subjected to some form of agitation by shaking, swirling or similar periodic motion to improve the very slow process of natural molecular interdiffusion, which is required to bring about the desired synthesis. Completion of such reactions may take several minutes but most frequently several hours. The development of a new pharmaceutical compound may require many hundreds, or even thousands, of such small volume reactions as the structure of a promising molecule is “tweaked” to achieve maximum efficacy with minimum undesirable side effects, and any improvement in yield with or without reduction in reaction time is most welcome to the industry.

### SUMMARY OF THE INVENTION

It is an object of this invention to provide new methods of operating reactors and reactors employing such methods which facilitate fast and high rate conversion chemical reactions involving liquid-liquid, solute-liquid, liquid-solid, solute-solid, liquid-gas and solute-gas reactions.

In accordance with the invention there is provided a method of operating a reactor to react together at least two reactants, at least one of which is in liquid state, the reactor being of the type comprising:

a rotor mounted for rotation about a longitudinal axis and having a cylindrical exterior surface disposed about the axis;

motor means connected to the rotor and operative to rotate it about the axis;

a stator enclosing the rotor and having a cylindrical interior surface disposed about the axis parallel and coaxial with the rotor exterior surface to provide between the two surfaces a reaction chamber of transverse annular cross section, preferably of uniform radial thickness along its length;

means for introducing reactants to be reacted together into the reaction chamber; and means for discharging reacted reactants from the reaction chamber;

the method including the steps of:

providing within the reaction chamber a shear transmitting fluid in gaseous state capable of transmitting shear force applied thereto by the moving rotor exterior surface to the stator interior surface;

feeding into the reaction chamber a quantity of the reactants with rotation of the rotor at least at a speed sufficient to spread the reactants under the urge of the shear transmitting fluid under centrifugal force over the stator interior surface as a reactant film of radial thickness 150 micrometers or less, preferably 120 micrometers or less, and more preferably 100 micrometers or less; and

simultaneously or subsequently rotating the rotor at a speed such as to apply to the reactant film via the shear transmitting fluid a shear force sufficient to disrupt molecular clusters therein and thereby facilitate molecular diffusion reaction between the reactants.

Also in accordance with the invention there is provided reactor apparatus for reacting together at least two reactants, at least one of which is in liquid state, the reactor being of the type comprising:

a rotor mounted for rotation about a longitudinal axis and having a cylindrical exterior surface disposed about the axis;

motor means connected to the rotor and operative to rotate it about the axis; a stator enclosing the rotor and having a cylindrical interior surface disposed about the axis parallel and coaxial with the rotor exterior surface to provide between the two surfaces a reaction chamber of transverse annular cross section, preferably of uniform radial thickness along its length;

means for introducing reactants to be reacted together into the reaction chamber; and

means for discharging reacted reactants from the reaction chamber;

wherein the radial dimension of the reaction chamber is not less than 1 mm;

the reaction chamber has therein a shear transmitting fluid in gaseous state capable of transmitting shear force applied thereto by the moving rotor exterior surface to the stator interior surface;

the means for introducing reactants into the reaction chamber is adapted to feed therein a quantity of the reactants with rotation of the rotor at least at a speed sufficient to spread the reactants under the urge of the shear transmitting fluid under centrifugal force over the stator interior surface as a reactant film of radial thickness not more than 150 micrometers;

and the rotor is capable of rotation at a speed such as to apply to the reactant film via the shear transmitting fluid a shear force sufficient to disrupt molecular clusters therein and thereby facilitate molecular diffusion reaction between the reactants.

The area of the stator interior surface may be such that a total of 2 ml of reagents will result in a reactant film on the stator interior surface of thickness 150 micrometers or less. The radial dimension of the reaction chamber may be between 5 mm and 500 mm, and preferably is at least 3 mm. Unwanted vapors and gases generated during the reaction may be removed from the reaction chamber.

The shear transmitting fluid may be air, a reactant gas or an inert gas. The rotor may be rotated at speeds between 30,000 and 80,000 r.p.m., and the consequent shear rate obtained in the reacting film may be between 150,000/sec and 800,000/sec.

The reactor may comprise sampling means for removing samples from the reacting film for determining the stage which the reaction has reached. The reactor may comprise a detector able to examine the film to determine the stage which the reaction has reached.

At least one reactant is in gaseous state and is entrained in the shear transmission fluid. Pressurized gas is introduced into the reaction chamber to purge liquid reagents and reacted reagents from the reaction chamber adhering to the stator interior surface.

### DESCRIPTION OF THE DRAWINGS

Methods and apparatus that are particular preferred embodiments of the invention will now be described, by way of example, with reference to the accompanying diagrammatic drawings, wherein:

FIGS. 1 through 5 are all a part side elevation and part cross section through a vertical longitudinal axis of an embodiment of apparatus of the invention in order to illustrate the principal construction features of such an apparatus, specific structural features being shown selectively in the figures so that they may be more clearly illustrated; and

FIG. 6 is a transverse cross section taken on the line 6-6 in FIG. 1.

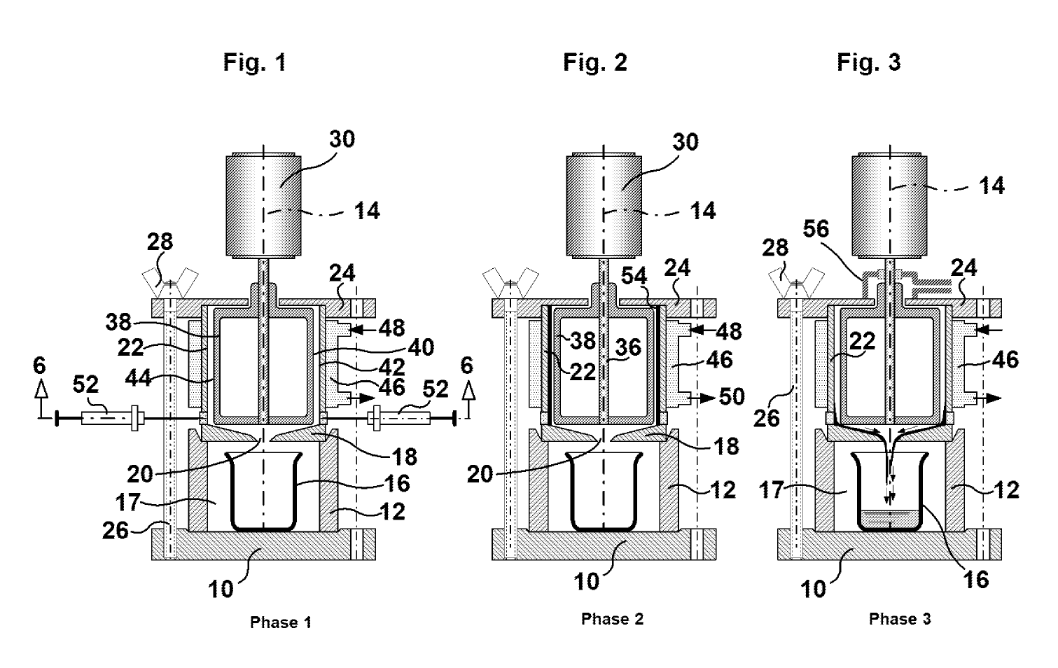

### DESCRIPTION OF THE INVENTION

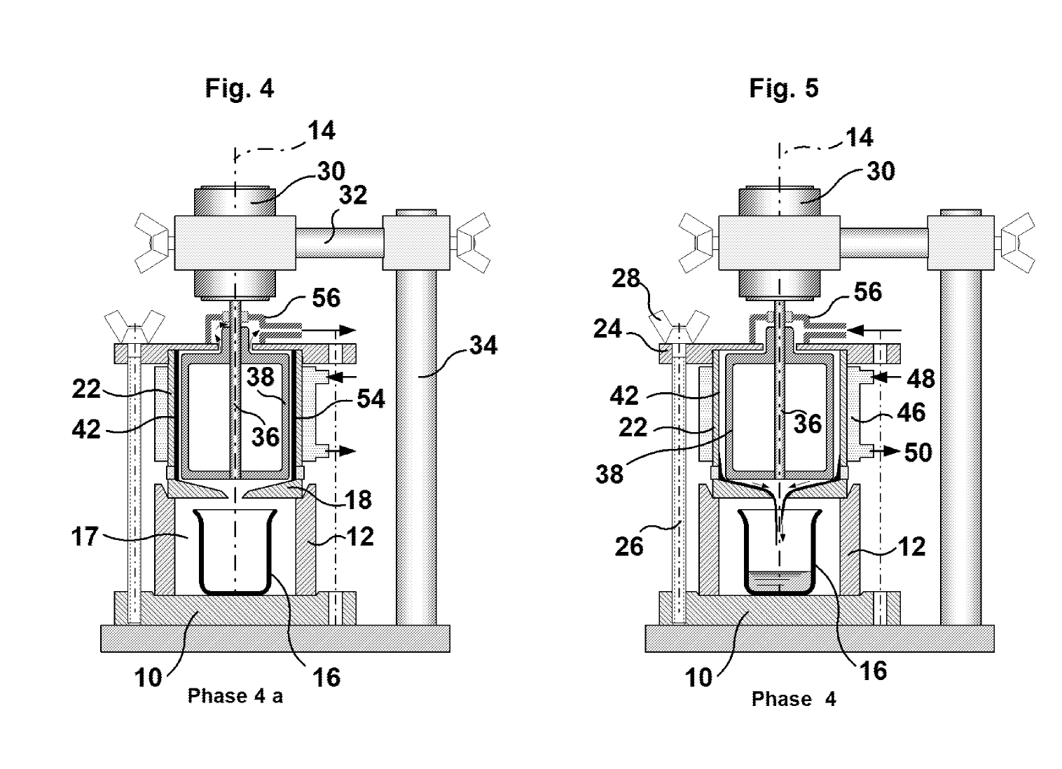

The apparatus comprises a base member 10 on which is mounted a cylindrical base tube 12 with its side wall struck about a vertical axis 14, a part of the wall provided having an opening (not shown) through which a beaker 16, or any equivalent vessel, may be inserted into and removed from a chamber 17 within the tube interior. An annular cap 18 having a central opening 20 centered on the axis 14 is mounted on the top end of the cylinder 12 and in turn supports a cylindrical stator tube 22, also having its wall struck about the axis 14. The top end of the tube 22 is closed by a cover plate 24, which also has a central opening 26 centered on the axis 14, the assembly of base plate 10, cylinders 12 and 22, cap 18 and cover plate 24 being held rigidly together by a plurality of circumferentially disposed longitudinal tie rods 26 (only one shown) and butterfly nuts 28. A high speed direct drive motor 30 is mounted above the assembly by a gantry arm 32 attached to a vertical post 34 (see FIGS. 4 and 5) with the axis of rotation of its shaft 36 coaxial with the axis 14. The lower end of the shaft carries a cylindrical rotor 38 mounted inside the tube 22, which comprises the cooperating stator of a reactor apparatus, the rotor having an external cylindrical surface 40 facing and extending parallel to internal cylindrical surface 42 of the stator, the two surfaces forming between them a reaction chamber 44 of transverse annular cross section and of uniform radial dimension along its length. The reactor is provided with temperature control means comprising a jacket 46 surrounding the stator cylinder and having inlet 48 and outlet 50 for a heat exchange medium, the medium employed comprising a heating or cooling fluid depending on whether the reaction taking place requires heating or cooling. The direct drive motor can be replaced by an indirect drive motor connected by a pulley assembly of known kind that will enable the speed of rotation of the rotor to be adjusted to a required value different from that of the motor.

The reaction chamber 44 is filled with a shear transmitting fluid, which in this embodiment can be air or, if air is likely to interfere with the reaction, a more inert gas such as nitrogen or argon. As the rotor spins its external surface 40, it applies rotational shear to the shear transmitting fluid, which is dragged circumferentially in the reaction chamber and in turn applies rotational shear to the stator internal surface 42. First and second reactants to be reacted together are fed into the reaction chamber under precise control as to flow via respective precision metering injectors 52, in this embodiment comprising 1 ml capacity injection syringes, disposed radially opposite to one another. This injection takes place while the rotor is rotated at a predetermined speed and the shear applied by the shear transmitting fluid immediately spreading the reactants over the stator internal surface 42 in the form of a thin film 54 (FIGS. 2 and 4) of radial thickness determined by the quantity of the reactants and the area of the surface 42. The thin film of reacting reactants is immediately subjected to intense shear as it is dragged around the stator surface by the action of the shear transmitting fluid, the shear being such that molecular clusters within the film are disrupted sufficiently to facilitate reaction between the reactants, accelerating the reaction rate which otherwise would depend on slow, natural, unforced, molecular inter-diffusion, typically increasing such reaction rates by factors of from 100 to 1,000 times, as compared to comparable reactions performed in a conventional stirred tank. Thus, the uniformly interspersed reactants are subjected to intense, forced, molecular inter-diffusion caused by the high shear rates which can be obtained by sufficiently high speed rotation. The fact that such high speed, uniform, forced, molecular inter-diffusion of the reactant fluid molecules takes place can be verified by examining various chemical reactions performed in the reactor. Typically the rotor is rotated at speeds from about 30,000 to 80,000 rpm, resulting in shear rates of respectively of about 300,000/second to 800,000/second.

It has been found that the thickness of the film formed on the stator wall and subjected to the shear by the shear transmitting fluid is critical for successful facilitation of the required molecular interdiffusion reaction, and a practical upper limit of the thickness is about 150 micrometers. It has been found advantageous to reduce the thickness to a lower value of 120 micrometers, and preferably as low as 100 micrometers. The capacity of a reactor of specific size does of course decrease with decrease in the film thickness, but this is immaterial with many reactions required for the production of APIs, since the quantities involved are already extremely small e.g. 2 ml or less. The use of a gaseous fluid as a shear transmitting medium gives a required flexibility as to the radial dimension required for the reaction chamber 44 and this can be as much as 100-500 mm. Thus, any attempt to produce a reaction apparatus with a rotor and stator forming a reaction chamber with a radial spacing between the cooperating surfaces of the required film dimensions encounters considerable design and manufacturing problems, the most difficult of which to solve are dimensional changes at the high speeds of rotation required and inevitable temperature changes caused by the reaction itself and frictional drag of the reagents against the relatively moving surfaces. All of these problems are solved simply and elegantly by the methods and apparatus of the invention. A specific embodiment of apparatus intended for use with reactions involving approximately 2 ml or less of total reagent volume employs a stator with an internal surface 40 of 5 cm (2 inch) diameter and of 5 cm (2 inch) axial length, while the rotor external diameter is 4.75 cm (1.9 inch) to give a radial dimension for the reaction passage of 0.125 cm (0.05 inch). By contrast the desired maximum thickness of the reagent film 54 is 0.015 cm, and preferably 0.012 cm or less.

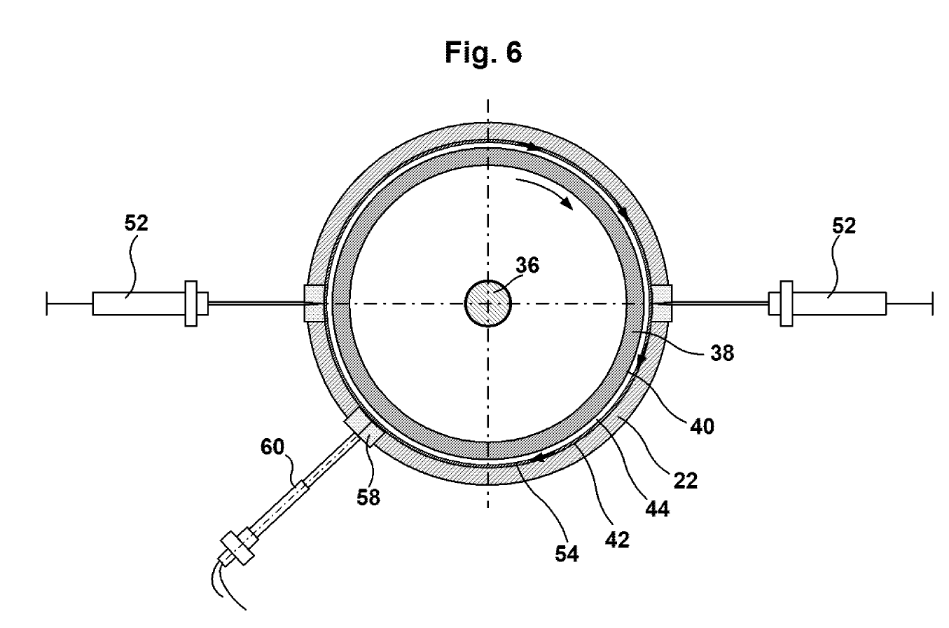

Many different permutations of reactants may be employed as long as at least one of them is in liquid state to permit the formation of the required liquid film on the stator inner wall. For example, one may be a solid material in highly divided form that is injected as a powder or a slurry. Again, one may be in gaseous or vapor state that is introduced into the shear transmitting fluid. Many reactions will result in the production of vapors and gases that need to be removed to avoid undesired side reactions or to influence the chemical equilibrium of a reaction and this is done by the provision of a shroud 56 (FIGS. 3 through 5) surrounding the opening in the top plate 24, the shroud providing a plenum in which a vacuum can be drawn for this purpose. It is usually desirable to be able to monitor the progress of a reaction, although this has sometimes been found to be difficult with many reactions owing the extreme high speeds at which they are completed, and with this embodiment this may be done, for example, by the provision of a sampling septum 58 (FIG. 6) in the side wall 22 of the stator. The septum may be employed to connect any suitable sampling and/or monitoring device to the reaction chamber interior, such as a microliter sampling pipette 60, which can include a monitor such as a miniature fiber optic spectrometer or infrared detector.

After the required reaction time, which can be from less than one second to several minutes, the rotor is stopped abruptly resulting in the draining of the reacted reactants by gravity into the beaker 16 (see FIGS. 3 and 5). The function of the plenum 56 can now be reversed and compressed air or nitrogen, heated if necessary, can be blown into the reaction chamber to flush out any residual liquid clinging to the rotor or stator walls and force it into the beaker below

It is vitally important in designing processes for the interaction of fluids, and in designing apparatus wherein such processes are to take place, to understand as fully as possible the “mechanics” of the interactions, and this becomes even more important when such interactions are chemical reactions that will result in new products. The following is presented as an abbreviated version of my understanding to date of the mechanics of such interactions, although I do not intend the scope of the invention to be limited in any way by this presentation. A more detailed presentation will be found in my prior U.S. application Ser. No. 10/656,627 (Publication No. 20050053532A1 of Mar. 10, 2005) the disclosure of which is incorporated herein by this reference. It is believed that achievement of fast inter-diffusion is hampered significantly in all chemical reactions by the diffusion retarding preponderance of what have been referred to by a number of different two word terms, the first of which is “molecular” or “cybotactic” and the second of which is “clusters”, or “swarms” or “domains”. Another term sometimes used is pseudo-compounds. For convenience I have adopted the term “molecular clusters” as my preferred reference to these, unless quoting from some pertinent publication. These molecular clusters inherently occur in liquids below their boiling points, within which clusters the molecules are anisotropically ordered from a kinematics point of view. Such ordering impedes rapid, natural interdiffusion due to the highly coupled oscillation mode of the molecules within the clusters, consisting of large numbers of molecules oscillating in unison and unidirectionally on a cluster scale <100 nm. The problem that arises is to find some way in which practically and economically these molecular clusters can be broken up or sufficiently disturbed so as to greatly facilitate un-clustered, individual reactant molecules to encounter each other on a one on one basis and thereby permitting very rapid and efficient reactions to take place. The present invention provides such a solution.

### INDEX OF REFERENCE NUMERALS

10. Apparatus base

12. Base cylinder

14. Apparatus and rotor axis

16. Beaker receiving reacted reagents

17. Chamber in base cylinder 12

18. Annular cap

20. Central opening in annular cap 18

22. Cylindrical stator tube

24. Cover plate for tube 22

26. Tie rods holding assembly together

28. Butterfly nuts on tie rods 26

30. Direct drive motor

32. Gantry arm supporting motor

34. Vertical post supporting gantry arm

36. Motor shaft

38. Cylindrical rotor on motor shaft

40. Rotor external cylindrical surface

42. Stator internal cylindrical surface

44. Reaction chamber between surfaces 40 and 42

46. Heat exchange jacket about stator cylinder tube 22

48. Inlet to heat exchange jacket

50. Outlet from heat exchange jacket

52. Precision metering injectors

54. Reactant film

56. Shroud for vapor/gas removal and insertion

58. Sampling septum

60. Sampling pipette

I claim

1. Method of operating a reactor to react together at least two reactants, at least one of which is in liquid state, the reactor being of the type comprising:
a rotor mounted for rotation about a longitudinal axis and having a cylindrical exterior surface disposed about the axis;
motor means connected to the rotor and operative to rotate it about the axis;
a stator enclosing the rotor and having a cylindrical interior surface disposed about the axis parallel and coaxial with the rotor exterior surface to provide between the two surfaces a reaction chamber of transverse annular cross section, preferably of uniform radial thickness along its length;
means for introducing reactants to be reacted together into the reaction chamber; and
means for discharging reacted reactants from the reaction chamber;
the method including the steps of:
providing within the reaction chamber a shear transmitting fluid in gaseous state capable of transmitting shear force applied thereto by the moving rotor exterior surface to the stator interior surface;
feeding into the reaction chamber a quantity of the reactants with rotation of the rotor at least at a speed sufficient to spread the reactants under the urge of the shear transmitting fluid over the stator interior surface as a reactant film of radial thickness 150 micrometers or less, preferably 120 micrometers or less, and more preferably 100 micrometers or less; and
simultaneously or subsequently rotating the rotor at a speed such as to apply to the reactant film via the shear transmitting fluid a shear force sufficient to disrupt molecular clusters therein and thereby facilitate molecular diffusion reaction between the reactants.

2. A method as claimed in claim 1, wherein the area of the stator interior surface is such that a total of 2 ml of reagents will result in a reactant film on the stator interior surface of thickness 150 micrometers or less.

3. A method as claimed in claim 1, wherein the radial dimension of the reaction chamber is between 5 mm and 500 mm, and preferably is at least 5 mm.

4. A method as claimed in claim 1, wherein unwanted vapors and gases generated during the reaction are removed from the reaction chamber.

5. A method as claimed in claim 1, wherein the shear transmitting fluid is air or an inert gas.

6. A method as claimed in claim 1, wherein the rotor is rotated at speeds between 30,000 and 80,000 r.p.m., and the shear rate applied to the reacting film is between 50,000 and 800,000 sec⁻¹.

7. A method as claimed in claim 1, wherein the reactor comprises sampling means for removing samples from the reacting film for determining the stage which the reaction has reached.

8. A method as claimed in claim 1, wherein the reactor comprises a detector able to examine the film to determine the stage which the reaction has reached.

9. A method as claimed in claim 1, wherein at least one reactant is in gaseous state and is entrained in the shear transmission fluid.

10. A method as claimed in claim 1, wherein pressurized gas is introduced into the reaction chamber to purge liquid reagents and reacted reagents from the reaction chamber adhering to the stator interior surface.

11. Reactor apparatus for reacting together at least two reactants, at least one of which is in liquid state, the reactor being of the type comprising:
a rotor mounted for rotation about a longitudinal axis and having a cylindrical exterior surface disposed about the axis;
motor means connected to the rotor and operative to rotate it about the axis;
a stator enclosing the rotor and having a cylindrical interior surface disposed about the axis parallel and coaxial with the rotor exterior surface to provide between the two surfaces a reaction chamber of transverse annular cross section, preferably of uniform radial thickness along its length;
means for introducing reactants to be reacted together into the reaction chamber; and
means for discharging reacted reactants from the reaction chamber;
wherein the radial dimension of the reaction chamber is not less than 1 mm;
the reaction chamber has therein a shear transmitting fluid in gaseous state capable of transmitting shear force applied thereto by the moving rotor exterior surface to the stator interior surface;
the means for introducing reactants into the reaction chamber is adapted to feed therein a quantity of the reactants with rotation of the rotor at least at a speed sufficient to spread the reactants under the urge of the shear transmitting fluid over the stator interior surface as a reactant film of radial thickness not more than 150 micrometers; and
the rotor is capable of rotation at a speed such as to apply to the reactant film via the shear transmitting fluid a shear force sufficient to disrupt molecular clusters therein and thereby facilitate molecular diffusion reaction between the reactants.

12. Apparatus as claimed in claim 11, wherein the area of the stator interior surface is such that a total of 2 ml of reagents will result in a reactant film on the stator interior surface of thickness 150 micrometers or less.

13. Apparatus as claimed in claim 11, wherein the radial dimension of the reaction chamber is between 5 mm and 500 mm, and preferably is at least 5 mm.

14. Apparatus as claimed in claim 11, and including means for removal from the reaction chamber of unwanted vapors and gases generated during the reaction.

15. Apparatus as claimed in claim 11, wherein the shear transmitting fluid is air or an inert gas.

16. Apparatus as claimed in claim 11, wherein the motor means are capable of rotating the rotor at speeds between 30,000 and 80,000 r.p.m.

17. Apparatus as claimed in claim 11, and comprising sampling means for removing samples from the reacting film for determining the stage which the reaction has reached.

18. Apparatus as claimed in claim 11, and comprising a detector able to examine the film to determine the stage which the reaction has reached.

19. Apparatus as claimed in claim 11, and comprising means for delivering at least one reactant in gaseous state into the reaction chamber to be entrained in the shear transmission fluid.

20. Apparatus as claimed in claim 11, and comprising means for introducing pressurized gas into the reaction chamber to purge liquid reagents and reacted reagents from the reaction chamber adhering to the stator interior surface.
